(19) United States
(12) Patent Application Publication
(10) Pub. No.: US 2019/0087369 A1
(43) Pub. Date: Mar. 21, 2019

(54) FULL-DUPLEX MEMORY ACCESS SYSTEMS AND METHODS FOR IMPROVED QUALITY OF SERVICE (QOS)

(71) Applicant: QUALCOMM Incorporated, San Diego, CA (US)

(72) Inventors: Lior Amarilio, Yokneam (IL); Syed Naseef, Bangalore (IN); Ghanashyam Prabhu, Bangalore (IN)

(21) Appl. No.: 15/709,550

(22) Filed: Sep. 20, 2017

(51) Int. Cl. G06F 13/28; G06F 13/16; G06F 5/06; G06F 13/42; G06F 13/24

(52) U.S. Cl. CPC G06F 13/287; G06F 13/1673; G06F 2205/067; G06F 13/4282; G06F 13/24; G06F 5/065

(57) ABSTRACT

Full-duplex memory access systems and methods for improved quality of service (QoS) are disclosed. In one aspect, a primary bus owner will evaluate an output from a secondary bus owner when the primary bus owner takes control of the bus to determine if the secondary bus owner has data to send to the primary bus owner and/or is in the midst of a bulk data transfer. If the evaluation determines that there is still data to be transferred, the primary bus owner may refrain from draining an internal register unless a full word is present in the register. By reducing memory access for a partial word in the register, QoS may be improved.

### BACKGROUND

### I. Field of the Disclosure

The technology of the disclosure relates generally to managing quality of service fulfillment during bulk memory transfers over a communication bus.

### II. Background

Computing devices are increasingly common throughout every sector of life. The prevalence of such computing devices is driven in part by the ever increasing array of functions and capabilities that such computing devices provide. One area that has seen many advances is the group of computing devices that may be referred to as mobile computing devices including smart phones, laptops, tablets, and the like. Such devices initially were limited to simple telephonic devices, but have evolved into multi-function multimedia platforms. Designers have incorporated multiple speakers and multiple microphones to support such multimedia functionality. To assist in managing such multiple audio components, various audio protocols and communication buses have been proposed. One popular communication bus is the Serial Low-power Inter-chip Media Bus (SLIMbus) and associated protocol promulgated by the MIPI Alliance. While SLIMbus started as a half-duplex audio protocol, it has evolved into a full-duplex protocol capable of not only audio transfers, but also bulk data transfers.

The current version of the SLIMbus specification is version 2.0, published 17 Aug. 2015 and adopted 18 Nov. 2015. This current version of SLIMbus defines the rules and roles of devices associated with the SLIMbus bus. For example, the bus may have a primary owner and a secondary owner. If the primary owner has data to send over the bus, the primary owner asserts an ownership token and sends the data. Only when the primary owner is not asserting its ownership token is the secondary owner allowed to assert an ownership token and send data.

Because the primary owner does not evaluate what the secondary owner is doing when the primary owner asserts ownership, the data transfer from the secondary owner may be pre-empted or interrupted. In many instances such pre-emption or interruption leaves a partial word in the primary owner's intake first in, first out (FIFO) register. The primary owner may drain such partial word to the memory element within the primary owner Elimination of repeated draining of partial words may improve the quality of service (QoS) of the primary owner.

### SUMMARY OF THE DISCLOSURE

Aspects disclosed in the detailed description include full-duplex memory access systems and methods for improved quality of service (QoS). In particular, a primary bus owner will evaluate an output from a secondary bus owner when the primary bus owner takes control of the bus to determine if the secondary bus owner has data to send to the primary bus owner and/or is in the midst of a bulk data transfer. If the evaluation determines that there is still data to be transferred, the primary bus owner may refrain from draining an internal register unless a full word is present in the register. By reducing memory access for a partial word in the register, QoS may be improved.

In this regard in one aspect, an integrated circuit (IC) is disclosed. The IC includes a communication bus interface configured to be coupled to a communication bus and configured to receive a bulk data transfer from a secondary owner of the communication bus. The IC also includes a register communicatively coupled to the communication bus interface configured to store data associated with the bulk data transfer. The IC also includes a memory element coupled to the register. The IC also includes a control system. The control system is configured to instruct the register to drain full words to the memory element. The control system is also configured to interrupt the bulk data transfer by asserting primary ownership of the communication bus. The control system is also configured to determine when the secondary owner still has data to transfer to a primary owner. When the secondary owner still has data to transfer, the control system is configured to refrain from draining the register to the memory element.

In another aspect, an IC is disclosed. The IC includes a means for coupling to a communication bus and configured to receive a bulk data transfer from a secondary owner of the communication bus. The IC also includes a register communicatively coupled to the means for coupling and configured to store data associated with the bulk data transfer. The IC also includes a means for storing data coupled to the register. The IC also includes a control system. The control system is configured to instruct the register to drain full words to the memory element. The control system is also configured to interrupt the bulk data transfer by asserting primary ownership of the communication bus. The control system is also configured to determine when the secondary owner still has data to transfer to a primary owner. When the secondary owner still has data to transfer, the control system is configured to refrain from draining the register to the memory element.

In another aspect, a method for controlling an IC is disclosed. The method includes beginning to receive a bulk data transfer over a communication bus from a secondary bus owner. The method also includes storing one or more words of the bulk data transfer in a register. The method also includes asserting primary ownership of the communication bus and interrupting the bulk data transfer. The method also includes determining that data remains to be received in the bulk data transfer. The method also includes refraining from draining a partial word from the register while data remains to be received in the bulk data transfer.

In another aspect, a system is disclosed. The system includes a full-duplex communication bus. The system also includes a first IC configured to be a primary owner of the full-duplex communication bus. The system also includes a second IC configured to be a secondary owner of the full-duplex communication bus. The first IC includes a communication bus interface configured to be coupled to the full-duplex communication bus and configured to receive a bulk data transfer from the second IC over the full-duplex communication bus. The first IC also includes a register communicatively coupled to the communication bus interface configured to store data associated with the bulk data transfer. The first IC also includes a memory element coupled to the register. The first IC also includes a control system. The control system is configured to instruct the register to drain full words to the memory element. The control system is also configured to interrupt the bulk data transfer by asserting primary ownership of the communication bus. The control system is also configured to determine when the secondary IC still has data to transfer to the first IC. When the second IC still has data to transfer, the control system is configured to refrain from draining the register to the memory element.

### BRIEF DESCRIPTION OF THE FIGURES

FIG. 1A is a block diagram of an exemplary Serial Low Power Inter-chip Media Bus (SLIMbus) system and in particular the message channel thereof;

FIG. 1B is a block diagram of the SLIMbus system of FIG. 1A and the channel-based links thereof;

FIG. 2 is a more detailed version of a block diagram of a SLIMbus system illustrating the physical layer, frame layer, and transport protocols of devices within the SLIMbus system;

FIG. 3 is a simplified block diagram of a primary bus owner having a memory element used in a bulk transfer;

FIG. 4 is a simplified block diagram of a secondary bus owner having a memory element used in a bulk transfer;

FIG. 5 is a flowchart of a conventional bulk transfer with interrupts by the primary bus owner and partial register drains to the memory element;

FIG. 6 is a flowchart of a bulk transfer with interrupts by the primary bus owner according to an exemplary aspect of the present disclosure that avoids partial register drains and improves quality of service (QoS); and

FIG. 7 is a block diagram of an exemplary processor-based system that can include the SLIMbus system of FIGS. 1A, 1B, and 2 that implements the methods of FIG. 6.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include full-duplex memory access systems and methods for improved quality of service (QoS). In particular, a primary bus owner will evaluate an output from a secondary bus owner when the primary bus owner takes control of the bus to determine if the secondary bus owner has data to send to the primary bus owner and/or is in the midst of a bulk data transfer. If the evaluation determines that there is still data to be transferred, the primary bus owner may refrain from draining an internal register unless a full word is present in the register. By reducing memory access for a partial word in the register, QoS may be improved.

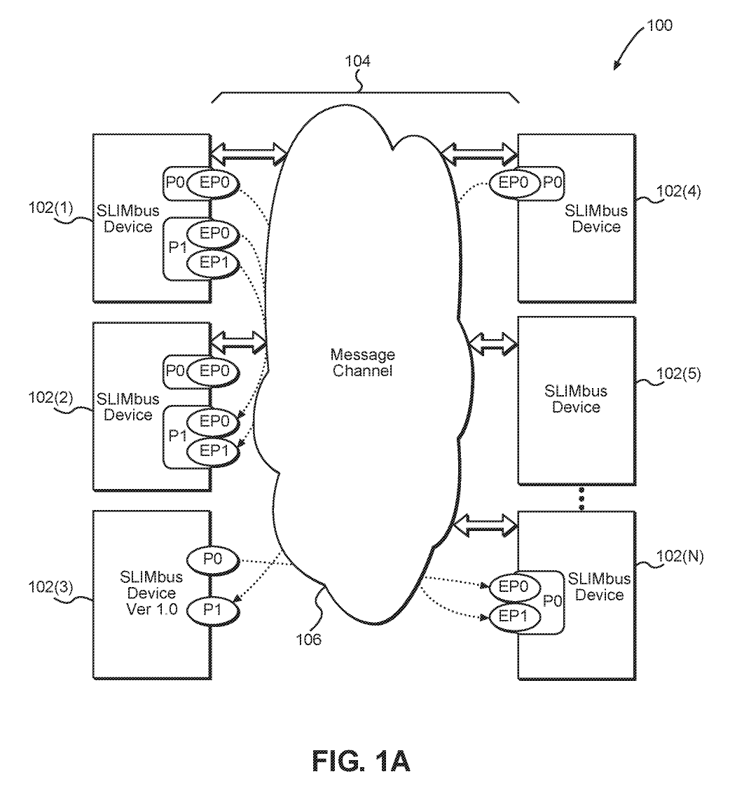

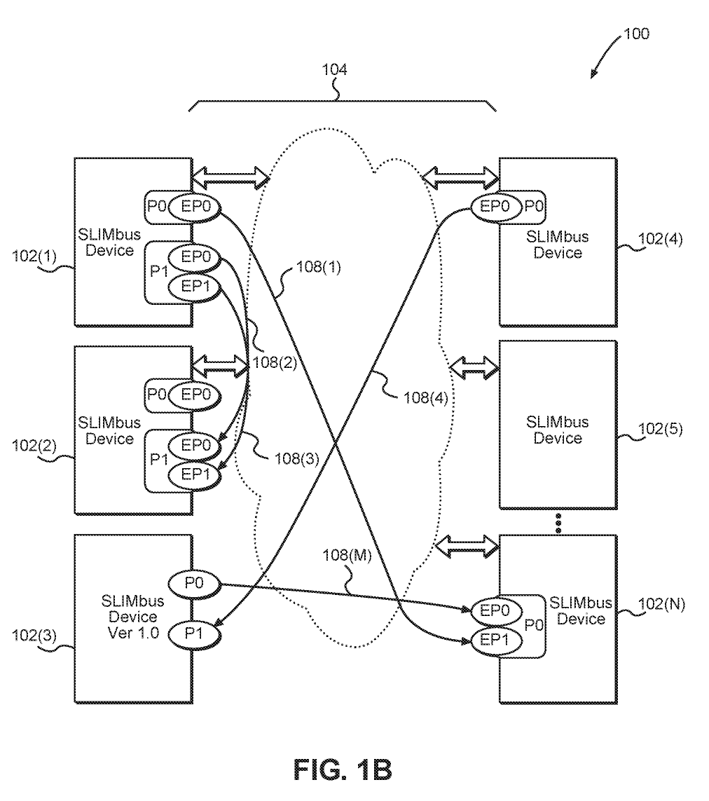

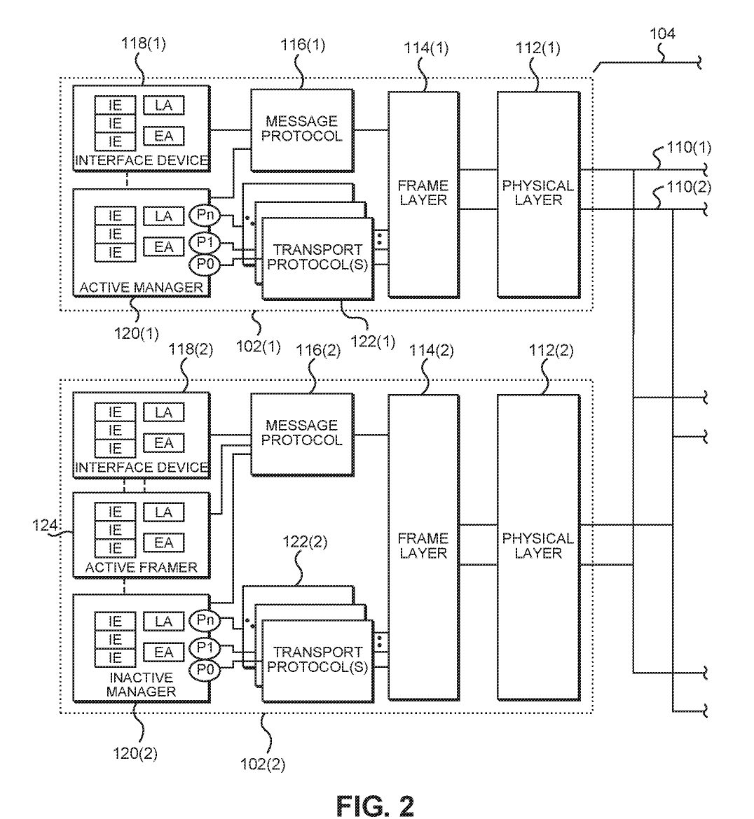

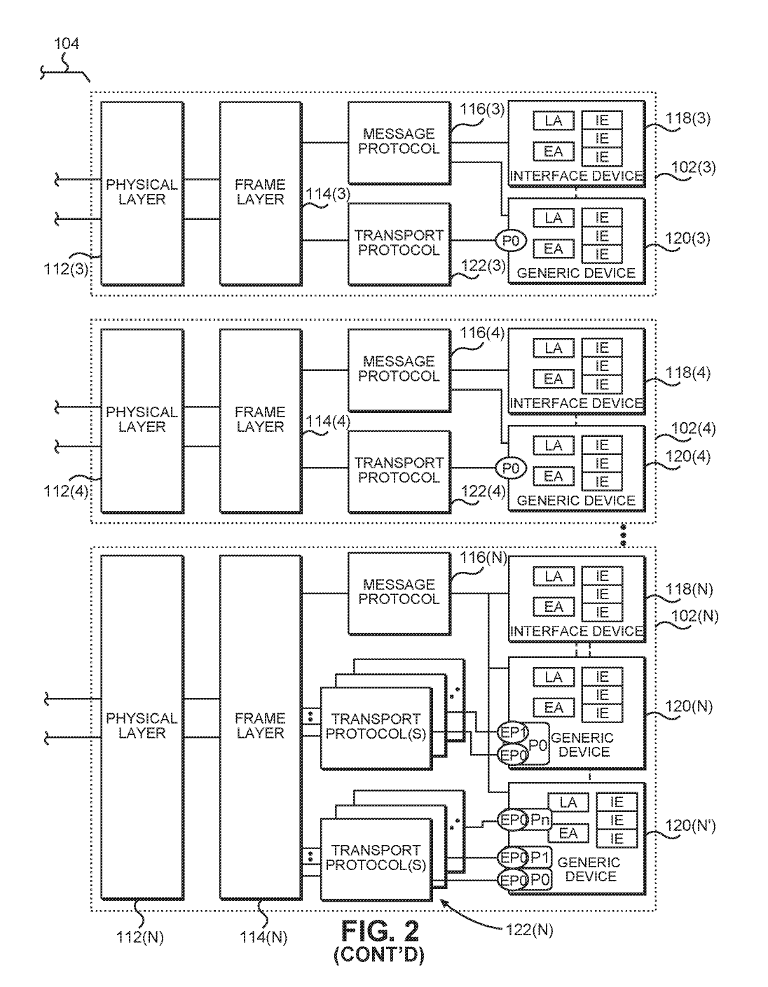

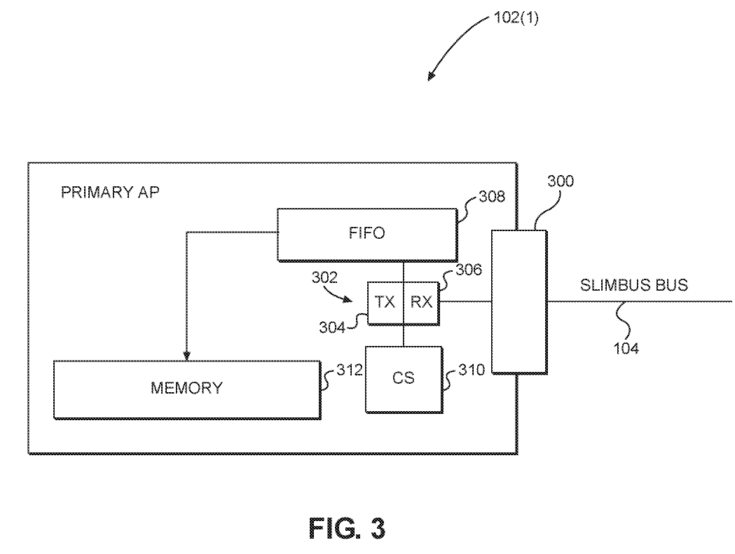

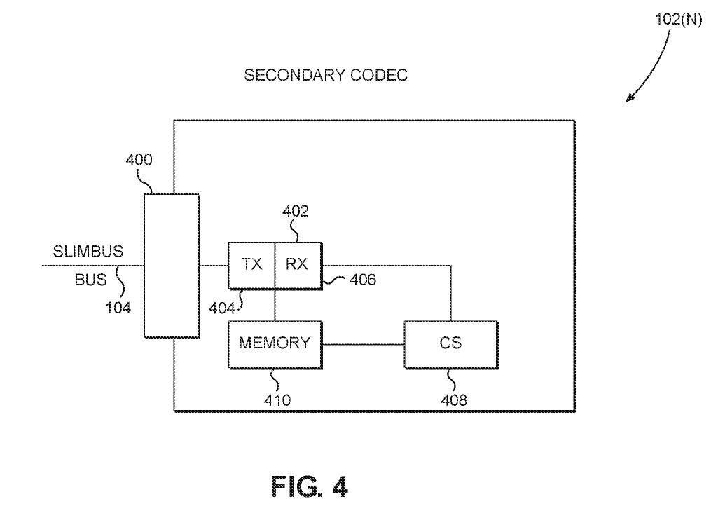

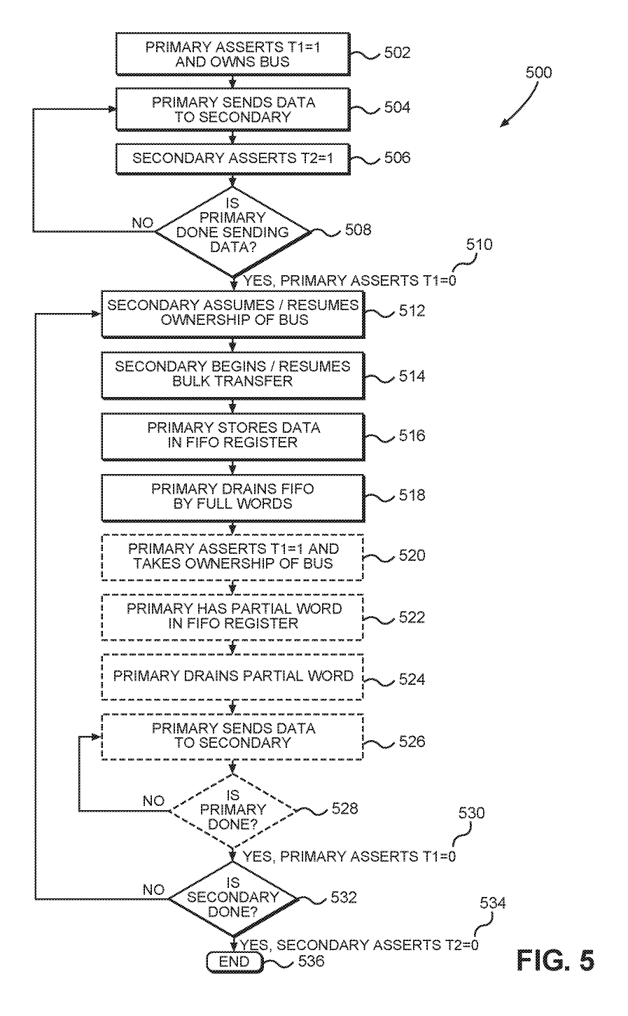

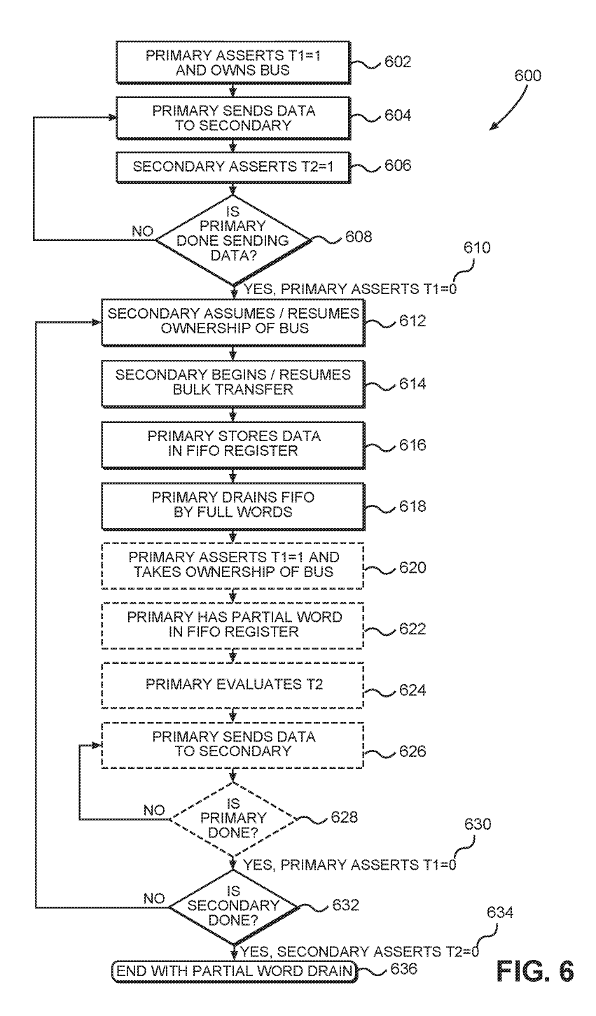

Before addressing specific details about the ways in which the QoS can be maintained, an overview of a Serial Low-power Inter-chip Media Bus (SLIMbus) system is provided with reference to FIGS. 1A, 1B and 2. Additional details about devices associated with the SLIMbus system are provided with reference to FIGS. 3 and 4. A discussion of conventional techniques is provided with reference to FIG. 5 to contrast with the discussion of exemplary aspects of the present disclosure, which begins with reference to FIG. 6.

In this regard, FIG. 1A is block diagram of a SLIMbus system 100. The SLIMbus system 100 includes a plurality of devices 102(1)-102(N) that are communicatively coupled to one another by a bus 104. Conceptually there is a “cloud” message channel 106 that allows messages to pass between different ones of the plurality of devices 102(1)-102(N).

In contrast, FIG. 1B illustrates the SLIMbus system 100 and particularly data channels 108(1)-108(M) that may exist between different ones of the plurality of devices 102(1)-102(N). While specific data channels 108(1)-108(M) are illustrated, it should be appreciated that different data channels may be created as needed or desired. It should be appreciated that FIGS. 1A and 1B come from version 2.0 of the SLIMbus specification published 17 August 2015, which explains how channels are set up and the messaging that takes place thereover.

FIG. 2 provides a less abstract view of the SLIMbus system 100 with conductors 110(1) and 110(2) specifically illustrated within the bus 104. Likewise, each of the plurality of devices 102(1)-102(N) includes a respective physical layer (PHY) 112(1)-112(N), frame layer 114(1)-114(N), message protocol logic 116(1)-116(N), interface device 118(1)-118(N), manager 120(1)-120(N), and one or more transport protocol logics 122(1)-122(N). Note that an active framer 124 may exist within one of the plurality of devices 102(1)-102(N) (e.g., device 102(2)). Likewise, the managers 120(1)-120(N) may be a generic device (e.g., managers 120(3), 120(4), 120(N), and 120(N′)). Still further, multiple generic devices may be present within a single device (e.g., device 102(N)), and some devices may have multiple sets of transport protocol logics (e.g., the device 102(N)). Again, the functions illustrated in FIG. 2 are further explained in the SLIMbus specification.

The SLIMbus specification contemplates traditional audio stream data transfers as well as bulk data transfers. Typically, there is a channel owner who controls use of a given channel on the bus 104. Other devices coupled to the channel may act as secondary owners, but are not able to take control of the channel until the primary owner relinquishes control. Further, when the primary owner wants to use the channel, the primary owner may reassert control, pre-empting or interrupting the secondary owner.

FIG. 3 illustrates an exemplary device 102(1) that acts as a primary bus owner (“primary”) during a bulk data transfer. The device 102(1) includes a bus interface 300, which may include the PHY 112(1) (FIG. 2). The bus interface 300 is sometimes referred to herein as a means for coupling to a communication bus. The bus interface 300 is coupled to a transceiver 302 with a transmitter (TX) 304 and a receiver (RX) 306 therein. Conceptually, the transceiver 302 is located in the interface device 118(1) (FIG. 2). Data received by the receiver 306 is stored initially in a first in first out (FIFO) register 308. Periodically, a control system (CS) 310 instructs the FIFO register 308 to drain into a memory element 312. The memory element 312 is sometimes referred to herein as a means for storing data. Exemplary aspects of the present disclosure modify the process through which the FIFO register 308 is drained from a process 500 illustrated in FIG. 5 to a new process 600 illustrated in FIG. 6.

FIG. 4 illustrates another device 102(N) which acts as a secondary bus owner (“secondary”) during a bulk data transfer. The device 102(N) includes a bus interface 400, which may include the PHY 112(N). The bus interface 400 is coupled to a transceiver 402 that includes a transmitter (TX) 404 and a receiver (RX) 406 therein. Conceptually, the transceiver 402 is located in the interface device 118(N). A control system 408 operates to control the transceiver 402 and causes bulk data that is stored in memory 410 to be transmitted through the transceiver 402 across the bus 104.

Bulk transfers across the full-duplex bus 104 are based on ownership of the bus. The ownership of the bus is expressed by an owner token. One of the plurality of devices 102(1)-102(N) associated with the bus 104 is designated as a primary and another device of the devices 102(1)-102(N) is designated as a secondary. The primary is typically an application processor or the like while the secondary is typically an audio device such as a codec or microphone. In use, the primary owner may occasionally write to the secondary owner updates or the like. Similarly, the secondary owner may be an always-on microphone that captures a keyword and records subsequent spoken instructions (e.g., “Alexa [keyword], play music by THE MONKEES. [subsequent spoken instructions]”). The stored instructions are then passed to the application processor for processing and action thereon as part of a bulk transfer.

It is not uncommon for a bulk transfer of such stored instructions to the application processor to be interrupted one or more times by updates from the application processor to the codec. In the abstract, such interruptions are not problematic, but given how memory in the primary owner is accessed, such interruptions may have ramifications for QoS.

A conventional process 500 for a bulk transfer having interruptions is presented with reference to FIG. 5. In particular, the process 500 begins with the primary asserting T1=1, which causes the primary to own the bus (block 502). This assertion is sometimes referred to as an owner token. The primary sends data to the secondary (block 504). The secondary asserts T2=1 (block 506). This assertion is an indication that the secondary has data to send to the primary. However, since the primary currently is using the bus, the secondary waits. The control system of the primary determines if the primary is done sending data (block 508). If the answer is no, the process 500 loops back to block 504, and the secondary continues to assert T2=1. If the answer to block 508 is yes, then the primary asserts T1=0 and releases ownership of the bus (block 510). The secondary assumes (or resumes as explained below) ownership of the bus (block 512). The secondary begins (or resumes as explained below) bulk transfer of data to the primary (block 514). The primary stores the data in its FIFO register (block 516). To make the data transfers to the memory efficient, the primary drains full words of data (e.g., 8 bytes, 16 bytes, 24 bytes, etc.) to the memory element (block 518).

While this bulk data is being transferred, the primary may have data to send to the secondary. The following optional steps are shown as optional through the use dotted lines in FIG. 5. In such instance, the primary may assert T1=1 and take ownership of the bus (block 520). The primary does not consider the state of the FIFO register or whether the bulk data transfer is complete, and this may cause a partial word to be left in the FIFO register (e.g., 3 bytes, 7 bytes, etc.) (block 522). The primary drains this partial word to the memory element (block 524). The primary sends primary sourced data to the secondary (block 526). That is, the primary has data different than the data just received. For example, the primary sourced data may be an audio stream or the like in response to a previous set of received instructions (e.g., the music by THE MONKEES used in example above). The control system of the primary determines if the primary is done (block 528). If the primary is not done, the process 500 continues with the primary continuing to send data. If however, the primary is done, the primary asserts T1=0 and releases ownership of the bus (block 530). The secondary has kept T2=1 and the control system of the secondary determines if the secondary is done (block 532). If the secondary is not done, the secondary resumes ownership of the bus (block 512) and resumes the bulk transfer (block 514). If however, the secondary is done, then the secondary asserts T2=0 (block 534) and the process 500 ends (block 536). As part of the ending, the primary drains any final words and potentially one partial word out of the FIFO register. Thus, it is readily seen that depending on how many times the primary interrupts the secondary, there may be multiple times where the primary drains a partial word from the FIFO register to the memory element.

Exemplary aspects of the present disclosure reduce the number of partial word drains, which in turn improves the QoS. To do this, the primary 102(1) checks whether the secondary 102(N) has more data as evidenced by whether the secondary 120(N) is continuing to assert T2=1 before making a decision to drain the FIFO register 308. An exemplary process 600 is illustrated in FIG. 6. In particular, the process 600 begins with the primary asserting T1=1, which causes the primary 102(1) to own the bus 104 (block 602). This assertion is sometimes referred to as an owner token. The primary 102(1) sends data to the secondary 102(N) (block 604). The secondary 102(N) asserts T2=1 (block 606). This assertion is an indication that the secondary 102(N) has data to send to the primary 102(1). However, since the primary 102(1) currently is using the bus 104, the secondary 102(1) waits. The control system 310 of the primary 102(1) determines if the primary 102(1) is done sending data (block 608). If the answer is no, the process 600 loops back to block 604, and the secondary 102(N) continues to assert T2=1. If the answer to block 608 is yes, then the primary 102(1) asserts T1=0 and releases ownership of the bus 104 (block 610). The secondary 102(N) assumes (or resumes as explained below) ownership of the bus 104 (block 612). The secondary 102(N) begins (or resumes as explained below) bulk transfer of data to the primary 102(1) (block 614). The primary 102(1) stores the data in its FIFO register 308 (block 616). To make the data transfers to the memory element 312 efficient, the primary 102(1) drains full words of data (e.g., 8 bytes, 16 bytes, 24 bytes, etc.) to the memory element 312 (block 618).

While this bulk data is being transferred, the primary 102(1) may have data to send to the secondary 102(N). The following optional steps are shown as optional through the use dotted lines in FIG. 6. In such instance, the primary 102(1) may assert T1=1 and take ownership of the bus 104 (block 620). The primary 102(1) does not consider the state of the FIFO register 308 or whether the bulk data transfer is complete, and this may cause a partial word to be left in the FIFO register 308 (e.g., 3 bytes, 7 bytes, etc.) (block 622). The primary 102(1) evaluates T2 (block 624). If T2=1, then the primary 102(1) will hold the data in the FIFO register 308. If T2=0, then the secondary 102(N) is done with the bus 104 and the primary 102(1) will drain this partial word to the memory element 312. The primary 102(1) sends the data to the secondary 102(N) (block 626). Again, note that this data to the secondary is not the data just received from the secondary. The control system 310 of the primary 102(1) determines if the primary 102(1) is done (block 628). If the primary 102(1) is not done, the process 600 continues with the primary 102(1) continuing to send data. If however, the primary 102(1) is done, the primary 102(1) asserts T1=0 and releases ownership of the bus 104 (block 630). The secondary 102(N) has kept T2=1 and the control system 408 of the secondary 102(N) determines if the secondary 102(N) is done (block 632). If the secondary 102(N) is not done, the secondary 102(N) resumes ownership of the bus 104 (block 612) and resumes the bulk transfer from the point where it stopped when the primary asserted T1=1 (block 614). Note that this resumed data is fed into the same FIFO register 308, completing the partial word therein if such was present. Then once the FIFO register 308 has a full word, the FIFO register 308 is drained to the memory element 312. If however, the secondary 102(N) is done, then the secondary 102(N) asserts T2=0 (block 634) and the process 600 ends with the primary draining any remaining partial word from the FIFO register 308 (block 636). Thus, regardless of how many times the primary 102(1) interrupts the secondary 102(N), the only time a partial word may be drained from the FIFO register 308 to the memory element 312 is when the bulk transfer is completed.

The full-duplex memory access systems and methods for improved quality of service (QoS) according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

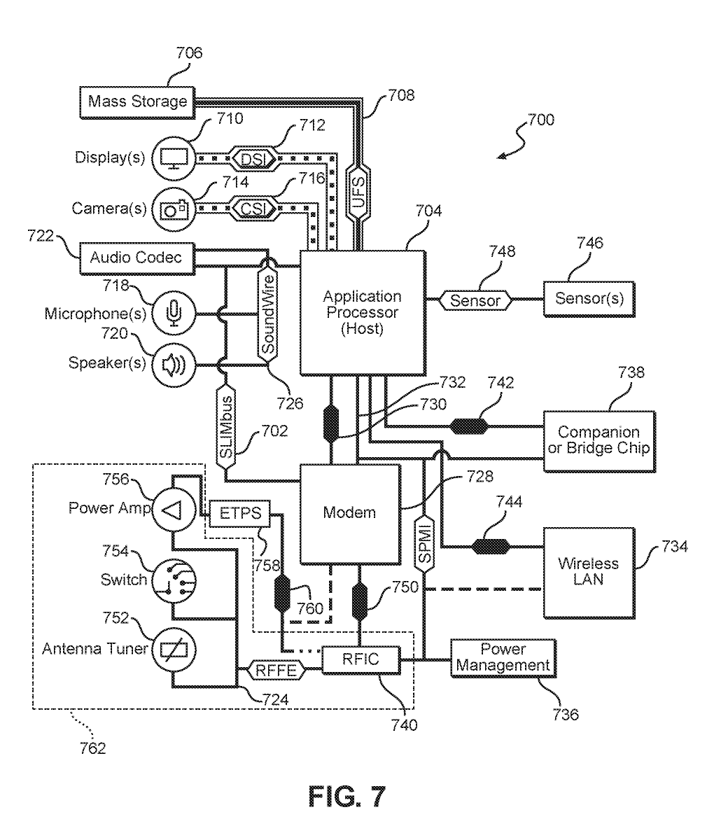

In this regard, FIG. 7 illustrates an example of a processor-based system instantiated in a mobile terminal 700 that may incorporate a SLIMbus system, such as the SLIMbus system 100 illustrated in FIGS. 1A, 1B, and 2. In this regard, FIG. 7 is a system-level block diagram of an exemplary mobile terminal 700 such as a smart phone, mobile computing device tablet, or the like. While a mobile terminal is particularly contemplated as being capable of benefiting from exemplary aspects of the present disclosure, it should be appreciated that the present disclosure is not so limited and may be useful in any system having a SLIMbus or other full-duplex bus that allows interrupts during bulk transfers.

With continued reference to FIG. 7, the mobile terminal 700 includes a SLIMbus 702, which may be coupled to an application processor 704 (sometimes referred to as a host) that communicates with a mass storage element 706 through a universal flash storage (UFS) bus 708. The application processor 704 may further be connected to a display 710 through a display serial interface (DSI) bus 712 and a camera 714 through a camera serial interface (CSI) bus 716. Various audio elements such as a microphone 718, a speaker 720, and an audio codec 722 may be coupled to the application processor 704 through the SLIMbus 702. Additionally, the audio elements may communicate with each other through a SOUNDWIRE™ bus 726. A modem 728 may also be coupled to the SLIMbus 702. The modem 728 may further be connected to the application processor 704 through a peripheral component interconnect (PCI) or PCI express (PCIe) bus 730 and/or a system power management interface (SPMI) bus 732.

With continued reference to FIG. 1, the SPMI bus 732 may also be coupled to a wireless local area network (WLAN) integrated circuit (IC) (WLAN IC) 734, a power management integrated circuit (PMIC) 736, a companion IC (sometimes referred to as a bridge chip) 738, and a radio frequency IC (RFIC) 740. It should be appreciated that separate PCI buses 742 and 744 may also couple the application processor 704 to the companion IC 738 and the WLAN IC 734. The application processor 704 may further be connected to sensors 746 through a sensor bus 748. The modem 728 and the RFIC 740 may communicate using a bus 750.

With continued reference to FIG. 7, the RFIC 740 may couple to one or more RFFE elements, such as an antenna tuner 752, a switch 754, and a power amplifier 756 through the RFFE bus 724. Additionally, the RFIC 740 may couple to an envelope tracking power supply (ETPS) 758 through a bus 760, and the ETPS 758 may communicate with the power amplifier 756. Collectively, the RFFE elements, including the RFIC 740, may be considered an RFFE system 762. It should be appreciated that the RFFE bus 724 may be formed from a clock line and a data line (not illustrated).

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An integrated circuit (IC) comprising:
a communication bus interface configured to be coupled to a communication bus and configured to receive a bulk data transfer from a secondary owner of the communication bus;
a register communicatively coupled to the communication bus interface configured to store data associated with the bulk data transfer;
a memory element coupled to the register; and
a control system configured to:
instruct the register to drain full words to the memory element;
interrupt the bulk data transfer by asserting primary ownership of the communication bus;
determine when the secondary owner still has data to transfer to a primary owner; and
when the secondary owner still has data to transfer, refrain from draining the register to the memory element.

2. The IC of claim 1, wherein the communication bus interface comprises a Serial Low-power Inter-chip Media Bus (SLIMbus) interface.

3. The IC of claim 1, wherein the register comprises a first in, first out (FIFO) register.

4. The IC of claim 1, wherein the control system is configured to read a T2 value asserted by the secondary owner to determine when the secondary owner still has data to transfer to the primary owner.

5. The IC of claim 1, wherein the IC comprises the primary owner.

6. The IC of claim 1, wherein the control system is configured to drain a partial word from the register when the bulk data transfer from the secondary owner is complete.

7. The IC of claim 1, wherein the control system is configured to assert the primary ownership of the communication bus by asserting a T1 value equal to one (1).

8. The IC of claim 1, wherein the control system is configured to release the primary ownership of the communication bus by asserting a T1 value equal to zero (0).

9. The IC of claim 1 integrated into a device selected from the group consisting of:
a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player;
an automobile; a vehicle component; avionics systems; a drone; and a multicopter.

10. An integrated circuit (IC) comprising:
a means for coupling to a communication bus and configured to receive a bulk data transfer from a secondary owner of the communication bus;
a register communicatively coupled to the means for coupling and configured to store data associated with the bulk data transfer;
a means for storing data coupled to the register; and
a control system configured to:
instruct the register to drain full words to the memory element;
interrupt the bulk data transfer by asserting primary ownership of the communication bus;
determine when the secondary owner still has data to transfer to a primary owner; and
when the secondary owner still has data to transfer, refrain from draining the register to the memory element.

11. A method for controlling an integrated circuit (IC) comprising:
beginning to receive a bulk data transfer over a communication bus from a secondary bus owner;
storing one or more words of the bulk data transfer in a register;
draining full words from the register to a memory element;
asserting primary ownership of the communication bus and interrupting the bulk data transfer;
determining that data remains to be received in the bulk data transfer; and
refraining from draining a partial word from the register while data remains to be received in the bulk data transfer.

12. The method of claim 11, wherein beginning to receive comprises beginning to receive over a Serial Low-power Inter-chip Media Bus (SLIMbus).

13. The method of claim 11, further comprising asserting the primary ownership by asserting a T1 value equal to one (1).

14. The method of claim 11, wherein storing the one or more words in the register comprises storing the one or more words in a first in, first out (FIFO) register.

15. The method of claim 11, further comprising draining the partial word from the register when the bulk data transfer is complete.

16. A system comprising:
a full-duplex communication bus;
a first integrated circuit (IC) configured to be a primary owner of the full-duplex communication bus; and
a second IC configured to be a secondary owner of the full-duplex communication bus;
the first IC comprising:
a communication bus interface configured to be coupled to the full-duplex communication bus and configured to receive a bulk data transfer from the second IC over the full-duplex communication bus;
a register communicatively coupled to the communication bus interface configured to store data associated with the bulk data transfer;
a memory element coupled to the register; and
a control system configured to:
instruct the register to drain full words to the memory element;
interrupt the bulk data transfer by asserting primary ownership of the communication bus;
determine when the secondary IC still has data to transfer to the first IC; and
when the second IC still has data to transfer, refrain from draining the register to the memory element.
